(19) United States
(12) Patent Application Publication
(10) Pub. No.: US 2025/0307776 A1
(43) Pub. Date: Oct. 2, 2025

(54) METHOD AND APPARATUS FOR VIEW GENERATION, ELECTRONIC DEVICE, AND STORAGE MEDIUM

(71) Applicant: Beijing Zitiao Network Technology Co., Ltd., Beijing (CN)

(72) Inventors: Linxuan SHI, Beijing (CN); Siyuan ZHANG, Beijing (CN); Maoqi LI, Beijing (CN)

(21) Appl. No.: 18/864,364

(22) PCT Filed: Oct. 23, 2023
(86) PCT No.: PCT/CN2023/125898

§ 371 Date: Nov. 8, 2024

(30) Foreign Application Priority Data
Oct. 26, 2022 (CN) 202211319707.X

(51) Int. Cl. G06Q 10/10; G06F 3/0486; G06F 16/26

(52) U.S. Cl. CPC G06Q 10/103; G06F 3/0486; G06F 16/26

(57) ABSTRACT

Disclosed are a view generation method and apparatus, an electronic device, and a storage medium. The method includes: acquiring project management data corresponding to a target user; processing the project management data based on a preset data splitting dimension to obtain at least one panel view; and generating and displaying, based on the at least one panel view, a lane view corresponding to a target view dimension.

### CROSS-REFERENCE TO RELATED APPLICATION(S)

This application claims priority to Chinese Patent Application No. 202211319707.X, filed with the China National Intellectual Property Administration on Oct. 26, 2022, which is incorporated herein by reference in its entirety.

### FIELD

Embodiments of the present disclosure relate to the technology of project management, and for example, relate to a method and apparatus for view generation, an electronic device, and a storage medium.

### BACKGROUND

Currently, in the process from new product development and project approval to final product mass production, various business links generate a large amount of information for some enterprises, including development requirement information, product design materials, project process documents, etc. Establishing a project flowchart in project management can reflect the operation of the entire project.

### SUMMARY

The present disclosure provides a method and apparatus for view generation, an electronic device, and a storage medium.

In a first aspect, an embodiment of the present disclosure provides a method for view generation. The method includes:
acquiring project management data corresponding to a target user, where the project management data includes an executing user, an executing node, and anode attribute;
processing the project management data based on a preset data splitting dimension to obtain at least one panel view; and
generating and displaying, based on the at least one panel view, a lane view corresponding to a target view dimension.

In a second aspect, an embodiment of the present disclosure further provides an apparatus for view generation. The apparatus includes:
a project management data acquiring module, configured to acquire project management data corresponding to a target user, where the project management data includes an executing user, an executing node, and a node attribute;
a project management data processing module, configured to process the project management data based on a preset data splitting dimension to obtain at least one panel view; and
a lane view generation module, configured to generate and display, based on the at least one panel view, a lane view corresponding to a target view dimension.

In a third aspect, an embodiment of the present disclosure further provides an electronic device. The electronic device includes:
one or more processors; and
a storage apparatus, configured to store one or more programs.

The one or more programs, when executed by the one or more processors, cause the one or more processors to implement the method for view generation according to any one of the embodiments of the present disclosure.

In a fourth aspect, an embodiment of the present disclosure further provides a storage medium including computer-executable instructions. The computer-executable instructions, when executed by a computer processor, are used to perform the method for view generation according to any one of the embodiments of the present disclosure.

### BRIEF DESCRIPTION OF THE DRAWINGS

Throughout the accompanying drawings, the same or similar reference numerals denote the same or similar elements. It should be understood that the accompanying drawings are illustrative, and components and elements may not necessarily be drawn to scale.

FIG. 1 is a schematic flowchart of a method for view generation according to an embodiment of the present disclosure;

FIG. 2 is a schematic diagram of a panel view according to an embodiment of the present disclosure;

FIG. 3 is a schematic diagram of a lane view according to an embodiment of the present disclosure;

FIG. 4 is a schematic diagram of a control corresponding to a panel view according to an embodiment of the present disclosure;

FIG. 5 is a schematic flowchart of a method for view generation according to an embodiment of the present disclosure;

FIG. 6 is a schematic diagram of a blocked panel view according to an embodiment of the present disclosure;

FIG. 7 is a schematic diagram of a structure of an apparatus for view generation according to an embodiment of the present disclosure; and

FIG. 8 is a schematic diagram of a structure of an electronic device according to an embodiment of the present disclosure.

### DETAILED DESCRIPTION OF EMBODIMENTS

Due to a single display mode and poor data correlation of a project flowchart, when there are a plurality of concurrent businesses, it is difficult to ensure the organization and clarity of the project flowchart, which may lead to poor use experience for users.

Considering the above case, embodiments of the present disclosure provide a method and apparatus for view generation, an electronic device, and a storage medium.

The embodiments of the present disclosure will be described in more detail below with reference to the accompanying drawings. Although the accompanying drawings show some embodiments of the present disclosure, it should be understood that the present disclosure may be implemented in various forms, and should not be construed as being limited to the embodiments stated herein. On the contrary, these embodiments are provided for a more thorough and complete understanding of the present disclosure. It should be understood that the accompanying drawings and the embodiments of the present disclosure are for exemplary purposes only, and are not intended to limit the scope of protection of the present disclosure.

It should be understood that the steps recorded in the method implementations in the present disclosure may be performed in different orders and/or in parallel. Further, additional steps may be included and/or the execution of the illustrated steps may be omitted in the method implementations. The scope of the present disclosure is not limited in this aspect.

The term “including” used herein and variations thereof are open-ended inclusions, namely “including but not limited to”. The term “based on” is interpreted as “at least partially based on”. The term “an embodiment” means “at least one embodiment”; the term “another embodiment” means “at least one additional embodiment”; and the term “some embodiments” means “at least some embodiments”. Related definitions of other terms will be given in the description below.

It should be noted that concepts such as “first” and “second” mentioned in the present disclosure are only used to distinguish different apparatuses, modules, or units, and are not used to limit the order or relation of interdependence of functions performed by these apparatuses, modules, or units.

It should be noted that the modifiers “one” and “a plurality of” mentioned in the present disclosure are illustrative and not restrictive, and those skilled in the art should understand that unless otherwise explicitly specified in the context, the modifiers should be understood as “one or more”.

The names of messages or information exchanged between a plurality of apparatuses in the implementations of the present disclosure are provided for illustrative purposes only, and are not used to limit the scope of these messages or information.

It should be understood that before the use of the embodiments of the present disclosure, the user shall be informed of the type, range of use, use scenarios, etc., of personal information involved in the present disclosure in an appropriate manner in accordance with the relevant laws and regulations, and the authorization of the user shall be obtained.

For example, in response to receipt of an active request from the user, a prompt message is sent to the user to clearly inform the user that a requested operation will require access to and use of the personal information of the user. As such, the user can independently choose, based on the prompt message, whether to provide the personal information to software or hardware, such as an electronic device, an application, a server, or a storage medium, that performs the operations of the embodiments of the present disclosure.

As an optional but non-limiting implementation, in response to the receipt of the active request from the user, the prompt message may be sent to the user in the form of, for example, a pop-up window, in which the prompt message may be presented in text. Further, the pop-up window may also carry a selection control for the user to choose whether to “agree” or “disagree” to provide the personal information to the electronic device.

It should be understood that the above notification and user authorization obtaining process is only illustrative, which does not limit the implementations of the present disclosure, and other methods that comply with the relevant laws and regulations may also be applied to the implementations of the present disclosure.

It should be understood that data involved in this embodiment (including but not limited to the data itself and the access to or use of the data) shall comply with the requirements of the corresponding laws, regulations, and relevant provisions.

Before introducing the embodiments, application scenarios may be first exemplarily described. The embodiments of the present disclosure may be applied to any scenario with multi-dimensional view display. Exemplarily, in the process of processing any product or business, due to many links in an execution process, a large number of executors and corresponding project data are involved. When the project data is visually displayed, an existing display method is relatively simple, and correlation between various data is poor, making it difficult for the users to allocate project process nodes. In this case, based on the embodiments of the present disclosure, project management data may be organized into panel views based on preset dimensions. Further, these panel views may be displayed in multi-dimensional groups to generate lane views that satisfy personalized requirements of the users.

FIG. 1 is a schematic flowchart of a method for view generation according to an embodiment of the present disclosure. In this embodiment of the present disclosure, project management data is displayed in multi-dimensional groups. The method may be performed by an apparatus for view generation. The apparatus may be implemented in the form of software and/or hardware, and is optionally implemented by an electronic device. The electronic device may be a mobile terminal, a personal computer (PC) terminal, a server, or the like.

As shown in FIG. 1, the method includes:

S110: Acquire project management data corresponding to a target user.

The target user may be an operating user, or a user corresponding to a current login status of a system, or a user with permissions to view, organize, and schedule the project data. The project management data may be data used to represent an execution status of the entire execution process of a corresponding project. For example, the project management data includes an executing user and a processing content. The executing user may be executors associated with various execution stages of the project. The processing content may be a content used to describe a processing status of each stage of the project.

In practical applications, for projects established by enterprises for specific products or businesses, there will be several executing users associated with the corresponding project and data representing a project execution status from the start to the end of the project. To control each link of the project, project execution data may be organized into the project management data including the executing users and the processing content. Further, to more visually display an execution status of each executing node in the entire execution process of the project, the target user may be allowed to move or adjust a task volume of each node at any time, and the project management data corresponding to the target user can be acquired first, such that the target user can organize and perform other processing on the acquired project management data.

S120: Process the project management data based on a preset data splitting dimension to obtain at least one panel view.

In this embodiment, the data splitting dimension may be preset and serves as a basis for splitting and organizing the data. It should be noted that the data splitting dimension may be arbitrarily set based on user and project requirements, and the user may also newly add or delete preset data splitting dimensions. For example, the data splitting dimension includes at least one of a role dimension, a permission dimension, a progress dimension, a processing time dimension, a requirement processing quantity dimension, a business type dimension, or a duration dimension. The settings have the advantages that the diversity of the data splitting dimension is embodied, and the personalized requirements of the users are satisfied.

The role dimension may represent splitting based on execution roles of processing nodes. Exemplarily, the execution roles may include a project leader, a structure leader, a service representative, etc. The permission dimension may represent splitting based on operating permissions of the user on the data. In practical applications, a project manager has higher corresponding permissions, and can not only view the project data, but also edit the project data; and a non-manager has lower corresponding permissions, and can only view the project data. The progress dimension may represent splitting based on an execution progress of executing nodes. It should be noted that the progress dimension may be set based on project requirements. Exemplarily, for a product development project, a corresponding progress dimension may include start, pending product review, pending design, pending technical review, pending scheduling, pending development initiation, etc. For a project dealing with defect issues, a corresponding progress dimension may include start, in process, resolved, reopened, and defect closed.

The processing time dimension may represent splitting based on processing time corresponding to the executing node. The requirement processing quantity dimension may represent splitting based on the number of projects associated with the executing user. In practical applications, the same executing user may process a plurality of projects of different types simultaneously. To avoid project processing congestion, the project management data may be split based on the requirement processing quantity dimension, thereby splitting project data for processing at least one project. The business type dimension may represent splitting of the project management data based on a current business type that needs to be processed. The duration dimension may represent splitting based on a duration corresponding to a project execution process.

It should be noted that the project management data includes various types of data, and when the project management data is processed, only some types of data may be required. Therefore, based on the preset data splitting dimension, data satisfying requirements may be split from the project management data, and by processing these data, user requirements of the target user can be satisfied. The settings have the advantages that the data processing efficiency can be improved, and the data can be more organized.

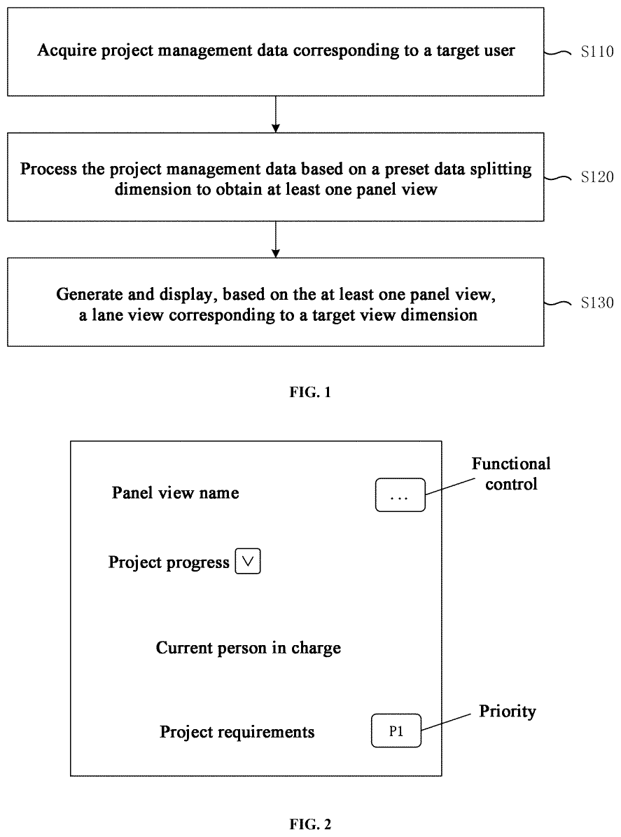

In this embodiment, the panel view may be a carrier for carrying specific information about a work item. Those skilled in the art should understand that the panel view may achieve project data visualization, thereby allowing the user to more visually classify existing work items, embodying task volumes in various statuses, and supporting the user to move and adjust the task volume at any time in various node statuses and work statuses according to project progress. Exemplarily, as shown in FIG. 2, FIG. 2 is a schematic diagram of a panel view, which may display information such as a panel view name, a current person in charge, project progress, project requirements, and priority.

In practical applications, to split and extract required data, one or more data splitting dimensions may be preset. After acquiring the project management data associated with the target user, the project management data may be split based on the preset data splitting dimension, thereby obtaining at least one panel containing the split data.

For example, processing the project management data based on the preset data splitting dimension to obtain at least one panel view includes: splitting the project management data into at least one set of sub-data based on the data splitting dimension; and generating the panel view based on the at least one set of sub-data.

In this embodiment, after obtaining the project management data, based on the data splitting dimension, project data corresponding to a current data splitting dimension may be extracted from the project management data, and the extracted data may be used as the sub-data.

It should be noted that when there are a plurality of data splitting dimensions, the project management data may be respectively split based on different data splitting dimensions to obtain at least one set of sub-data corresponding to each data splitting dimension. Additionally, when a panel view is generated based on each sub-data, a corresponding panel view may be generated based on the sub-data of the same data splitting dimension, or after the sub-data of different data splitting dimensions is combined, a panel view containing a plurality of sets of split data may be generated. This embodiment of the present disclosure does not impose specific limitations on this.

In practical applications, after obtaining the project management data, the project management data may be split based on the preset data splitting dimension to obtain at least one set of sub-data corresponding to the data splitting dimension. Further, each sub-data may be organized and visualized, thereby generating a corresponding panel view based on each sub-data. The settings have the advantages that by splitting the currently required project data from the project management data and processing the split sub-data, the project data processing efficiency can be improved. Additionally, the project management data may be more organized, thereby facilitating the user in organization and analysis of the data.

S130: Generate and display, based on the at least one panel view, a lane view corresponding to a target view dimension.

In this embodiment, the target view dimension may be a view layout display dimension corresponding to the lane view. For example, the target view dimension may be a horizontal layout dimension and/or a vertical layout dimension. The lane view may be a view consistent with a lane form.

It should be noted that the lane view may include horizontal lanes and vertical panel columns consistent with a vertical lane form. In the same lane view, the horizontal lanes and the vertical panel columns intersect at certain positions. Therefore, when the lane view corresponding to the target view dimension is constructed, the other view layout dimension may also be used as a reference factor to obtain the lane view that satisfies user requirements. Exemplarily, when a lane view corresponding to the horizontal layout dimension is generated, the vertical layout dimension may also be used as one of reference factors; and when a lane view corresponding to the vertical layout dimension is generated, the horizontal layout dimension may also be used as one of reference factors

For example, generating, based on at least one panel view, a lane view corresponding to a target view dimension includes: generating the lane view based on a horizontal layout dimension in the target view dimension and a vertical layout dimension corresponding to the data splitting dimension.

In this embodiment, the horizontal layout dimension may be used for horizontal arrangement of the panel views in a preset order. The vertical layout dimension may be used for vertical arrangement of the panel views in a preset order. It should be noted that the vertical layout dimension corresponds to the data splitting dimension. That is, in the lane view, the vertical layout of the panel views may be associated with the data splitting dimensions. Exemplarily, when the vertical layout dimension is set based on the requirement processing quantity dimension in the data splitting dimension, the vertical layout of the panel views in the lane view may represent a requirement processing content corresponding to each executor.

In practical applications, after obtaining each panel view, the current data splitting dimension may be determined first, and panel cards associated with the current data layout dimension are filtered out. Further, the panel cards are arranged based on the horizontal layout dimension and the vertical layout dimension to generate the lane view. The settings have the advantages that the arrangement and display of the panel cards can be more organized, and the effect of improving clarity and standardization of project process display is achieved.

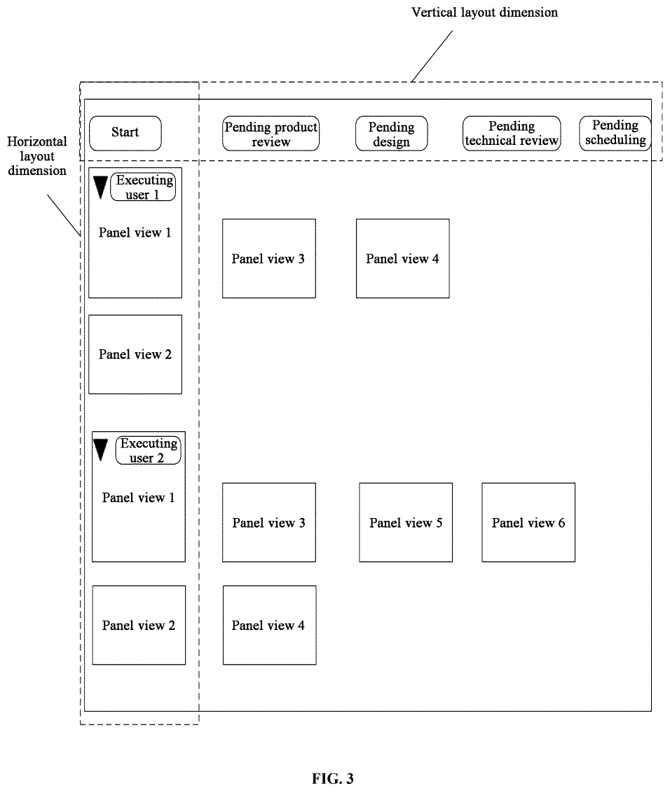

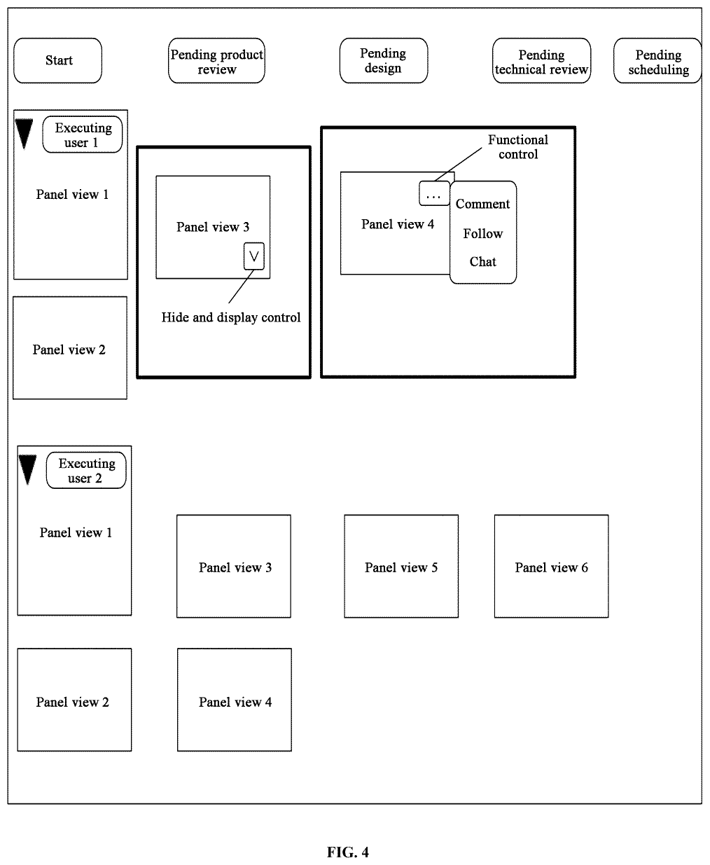

Exemplarily, as shown in FIG. 3, the vertical layout dimension may be set as project progress, and therefore vertical layout labels may be start, pending product review, pending design, pending technical review, pending scheduling, and pending development initiation. The horizontal layout dimension is set as a requirement processing quantity, and therefore horizontal layout labels may correspond to requirement processing contents of the executing users. When the lane view is constructed, the executing user 1 corresponds to four panel views, the executing user 2 corresponds to six panel views, the panel views corresponding to the executing user 1 may be arranged based on corresponding progress, and the panel views corresponding to the executing user 2 may be arranged based on corresponding progress, thereby obtaining the lane view.

In this embodiment, grouping display labels of the vertical layout dimension may be set at tops of the respective panel views, such that the existing panel views can be visually classified, thereby reflecting a number of tasks in each status. The grouping display labels of the vertical layout dimension are typically used for the user to view panel views under groups such as ongoing requirement nodes and defect statuses, thereby viewing the panel view in each status, and achieving position movement of the panel view in a drag-and-drop manner.

In this embodiment, the grouping of the horizontal layout dimension is displayed on left-side labels, and the panel views are re-grouped based on the grouping of the vertical layout dimension to achieve more organized arrangement and display of the panel views. Exemplarily, in a session scenario, grouping in the horizontal layout dimension may be performed based on participants to view the workload of a specific participant in a certain status, thereby facilitating the user to find a blocked node, and quickly drag and drop the panel view to adjust tasks, and assisting in more reasonable allocation of human resources.

In this embodiment, the lane view is split into two dimensions: [vertical layout dimension] and [horizontal layout dimension]. It should be noted that the lane view may support a multi-level grouping mode, with a maximum of three levels of grouping, thereby satisfying personalized multi-dimensional analysis requirements of the user.

It should also be noted that in addition to the lane view generated by default, a personalized view belonging to the target user may also be created and saved by triggering a [Save as New View] control.

Based on the above embodiments, the method further includes: determining, based on the data splitting dimension, at least one panel view located in a first column; and displaying a corresponding horizontal layout dimension at a target position of the at least one panel view.

In this embodiment, the target position may be a position used to display each panel view based on the horizontal layout dimension.

In practical applications, various panel views located in a first column of a view may be first determined based on the data splitting dimension. Further, the panel views located in the first column may also be re-classified based on the horizontal layout dimension, such that each panel view may be displayed at the corresponding target position based on the horizontal layout dimension. The settings have the advantages that the panel views may be secondarily grouped based on vertical grouping, such that the arrangement and display of the panel views may be more organized, and meanwhile, the user can dispatch and allocate the panel views conveniently, thereby satisfying user requirements.

Exemplarily, continuing to refer to FIG. 3, the horizontal layout dimension being the requirement processing quantity may be used as an example, and based on the requirement processing quantity, it is determined that all the panel views located in the first column are project requirements associated with executing users, namely the requirement processing quantity corresponding to the executing user 1, the requirement processing quantity corresponding to the executing user 2, the requirement processing quantity corresponding to the executing user 3, etc. Further, to view a processing progress of each project requirement, the progress dimension may be used as the vertical layout dimension. When a trigger operation on any area of each target view is detected, the processing progress for the project requirement corresponding to each executing user can be determined, thereby displaying the corresponding progress dimension at the target position. For example, if the requirement processing quantity corresponding to the executing user 1 is 4, and the processing progress for each project requirement includes two project requirements that are “Not Started” and two project requirements that are “In Process”, at the target position of the executing user 1, namely “ [symbol] ” in the figure, the 4 project requirements may be respectively arranged in the column of [Not Started] and the column of [In Process].

It should be noted that for the data splitting dimensions such as the business type, the requirement processing quantity, and the priority (grouping with enumerable options), two modes of displaying empty groups and not displaying empty groups may be supported; and for dimensions such as creation time, delay identifiers, and roles (grouping without enumerable options), displaying the empty groups is not supported.

It should be noted that in the panel view, a plurality of corresponding controls may also be developed according to different business logics, thereby providing diversified functions to the user. For example, the panel view includes a functional control and a basic information display control, thereby displaying basic information corresponding to the panel view when the basic information display control is triggered, and displaying a functional sub-control for comments, follows, and/or chats when the functional control is triggered.

In this embodiment, the functional control may be a touchable component for performing a corresponding function. The basic information display control may be a touchable component for displaying basic information about the panel view. It should be noted that the functional control and the basic information display control may be set in any area of the panel view and may be displayed in any form. This embodiment of the present disclosure does not impose specific limitations on this.

In practical applications, the functional control and the basic information display control may be preset in any area of the panel view. When a trigger operation on the basic information display control is detected, a response may be made to the trigger operation, and the panel view may be expanded to display corresponding basic information; or, the basic information corresponding to the panel view may be displayed within a preset range area of the panel view; or, the basic information corresponding to the panel view may be displayed within the preset range area of the panel view in the form of a pop-up window. This embodiment of the present disclosure does not impose limitations on this. When a trigger operation on the functional control is detected, a response may be made to the trigger operation so as to display the functional sub-control for comments, follows, and/or chats, thereby allowing the user to perform the trigger operation on the corresponding functional sub-control again based on the current requirement.

In this embodiment, when the user finds an interesting content in the various panel views and wants to comment on the part of content, the user may input a trigger operation on a comment sub-control, and when the trigger operation on the comment sub-control is detected, a comment interface corresponding to the panel view will pop up, thereby allowing the user to post a comment on the interface. When the user browses through the various panel views and wants to continuously follow related information and a future progress of the panel view, the user may input a trigger operation on a follow sub-control. When the trigger operation on the control is detected, a response may be made to the trigger operation, and various information associated with the panel view may be added to a follow list of the target user, thereby allowing the target user to view the related information about the panel view at any time. When project information associated with the panel view changes, the target user may also receive a corresponding notification. When the user wants to have a real-time dialogue with the executing user corresponding to any panel view, a trigger operation on a chat sub-control may be input. When the trigger operation on the chat sub-control is detected, a response may be made to the trigger operation. A dialogue box with the executing user corresponding to the panel view may be displayed on the interface in the form of a pop-up window or other forms, thereby achieving the real-time dialogue between the target user and the executing user. The settings have the advantages that functional diversity of the panel view is improved, a scope of interaction between the user and the panel view is enlarged, and it is beneficial to improve user activity and use experience for the panel view.

Exemplarily, as shown in FIG. 4, a display area of “ . . . ” in the panel view may be used as the functional control, and any area of the panel view is set as the basic information display control. When the trigger operation on the display area of “ . . . ” is detected, the functional sub-control for comments, follows, and/or chats can be displayed; and when the trigger operation on any area of the panel view is detected, the basic information corresponding to the panel view can be displayed.

It should be noted that the panel view can not only support the display of the basic information but also support a “view expansion” and a “view collapse” operation. Exemplarily, when a click operation is input for any panel view, a detail page of the panel view is opened, thereby facilitating the user to conveniently query project detailed information in scenarios such as morning meetings or weekly meetings.

It should be noted that to display as many panel views as possible within a limited interface space, display areas of the panel views may be folded, or after a detail display page corresponding to a corresponding panel view is opened, when the panel view needs to be restored to an initial status, the trigger operation may be input for any area of the panel view, such that the panel view can be folded and displayed. Based on this, for example, the panel view also includes a hide and display control, such that the panel view is displayed in a folded manner when the hide and display control is triggered.

In practical applications, the hide and display control may be preset in any area of the panel view. When the trigger operation on the control is detected, a preset folding area of the corresponding panel view may be folded to reduce an area of a display area of the panel view, thereby performing the display in the interface in the form of folded display. The settings have the advantages that a key content can be displayed in a minimal page space, so as to fully utilize the interface space and reflect interaction between the user and the interface.

Exemplarily, continuing to refer to FIG. 4, when a trigger operation on the hide and display control of the panel view 1 is detected, the panel view 1 may be displayed in a hidden manner.

It should be noted that after generating corresponding lane views based on the panel views, when the user browses through the panel views, the user may find that the content displayed in some of the panel views does not match the actual content, or the user wants to add a new project content to certain panel views, which may be achieved by editing these panel views, and the lane views may also be updated based on the edited panel views.

Based on the above embodiments, the method further includes: displaying a content editing page when a control for editing the content of the panel view is detected, and updating the panel view and a display position of the panel view in the lane view according to the edited content.

In this embodiment, the content editing page may convert the panel view into an editable form, thereby allowing the user to perform editing in the panel view. Alternatively, when the control for editing the content of the panel view is detected, various configuration information associated with the panel view is displayed in the interface in a list or other forms, thereby allowing the user to edit the content of the panel view on the page, and return to the panel view display interface when a trigger operation on a confirmation control is detected.

In practical applications, the content editing control may be set in any area of the panel view. When the trigger operation on the content editing control of any panel view is detected, the content editing page associated with the panel view may be displayed in the interface, thereby allowing the user to edit data displayed on the content editing page based on current requirements. Additionally, when the trigger operation on the confirmation control is detected, the interface may be restored to a lane view display interface. Meanwhile, the content in the corresponding panel view is updated based on the edited content, and the display position of the panel view in the lane view is also updated. The settings have the advantages that the project data in the panel view can be changed in real time, a lane view generation process is omitted, and the work efficiency of the target user is improved.

It should be noted that after generating the lane view, if the target user finds that the positions of some panel views do not match actual positions in the process of browsing through the various panel views, these panel views may be moved to corresponding positions to ensure that the display positions of the various panel views in the lane view are consistent with the actual situation.

Based on the above embodiments, the method further includes: updating, in the case of detecting a drag-and-drop operation on the panel view, the display position of the panel view in the lane view based on the drag-and-drop operation.

In this embodiment, a drag-and-drop operation control may be preset in any area of each panel view, and when a trigger operation on the control is detected, the drag-and-drop operation on the corresponding panel view can be achieved. Exemplarily, a drag-and-drop operation trigger duration may be preset. When it is detected that a trigger duration of an input device on the panel view reaches the preset trigger duration, it may be determined that the drag-and-drop operation on the panel view is triggered. For example, when it is detected that the trigger duration on any panel view reaches 2 s or more, it may be determined that the drag-and-drop operation on the panel view is triggered.

In practical applications, when the drag-and-drop operation on the panel view is detected, a response may be made to the drag-and-drop operation to operate the panel view based on the input device and then place the panel view at a corresponding position, thereby updating the display position of the panel view in the lane view. The settings have the advantages that the position of the panel view can be adjusted, and the user is assisted in conveniently operating and adjusting the panel view in various statuses, thereby ensuring continuous and quick interaction.

It should be noted that there may be cases that some panel views cannot be dragged. When the panel view cannot be dragged, a specific reason may be queried based on pre-established frequently-asked questions (FAQs). Exemplarily, the FAQs may include: 1: if there is mandatory information that has not been completed in the panel view, the panel view can only be dragged after the information is filled out; 2: under a fixed sorting rule, adjusting an order through dragging is not allowed within the same column; 3: only a single value can be changed during one-time dragging, currently, only single-dimension dragging is supported, and diagonal dragging in grouping is not supported; and 4: when fields that do not support dragging are detected, dragging cannot be implemented. The fields that do not support dragging may include: 1: fields involving changes to system calculations, such as creation time; 2: fields that the target user currently has no permission to modify; and 3: dragging grouping-supported controls, such as a business type, defect status start time, defect status end time, and a defect cumulative duration.

It should be noted that when the vertical layout dimension is the progress, a plurality of panel view display forms may be supported when the lane view is displayed, such that the user may perform selection based on own requirements. Exemplarily, “Show current progress only” and “Show all progress” may be included. The system may select [Show current progress only] by default, focusing on the current status of the panel view. [Show all progress] may also be selected for the scheduling display of the panel view by clicking on “ [symbol] ” on a right side of the lane view, thereby expanding to view all existing progress.

In this embodiment, a quick transition control may also be preset. For a panel view with a change permission, node or status transition may be achieved by inputting a trigger operation on the quick transition control on the panel view.

It should be noted that after generating the lane view, each panel view in the lane view may be filtered based on preset filtering conditions. Exemplarily, the filtering operation may be mainly applied to filter relevant requirements for a certain business type or role, and filtering options include: “belong to”, “contain”, “equal”, “empty”, and “within a range”.

It should also be noted that after generating the lane view, the panel views in the lane view may also be sorted based on preset sorting conditions. Specifically, the sorting of the panel views can be achieved by filtering fields associated with the sorting conditions. Exemplarily, a list of panel views from new to old may be obtained based on a creation time ascending order, thereby facilitating locating the most recently created panel views.

In this embodiment of the present disclosure, by acquiring the project management data corresponding to the target user, further processing the project management data based on the preset data splitting dimension to obtain the at least one panel view, and finally generating and displaying, based on the at least one panel view, the lane view corresponding to the target view dimension, the effect of the multi-dimensional grouping display of the panel views in the same display interface is achieved, thereby allowing the user to browse more clearly and visually, satisfying the personalized requirements of the user, and enhancing user experience.

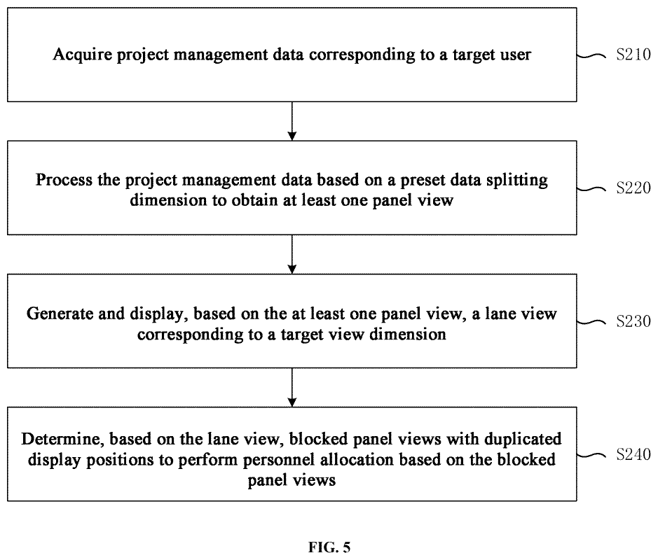

FIG. 5 is a schematic flowchart of a method for view generation according to an embodiment of the present disclosure. Based on the above embodiment, panel views with duplicated display positions may also be processed so as to allocate human resources. For a specific implementation, reference may be made to this embodiment. Technical terms that are the same with or corresponding to those in the above embodiment are not repeated herein.

As shown in FIG. 5, the method specifically includes the following steps:

S210: Acquire project management data corresponding to a target user.

S220: Process the project management data based on a preset data splitting dimension to obtain at least one panel view.

S230: Generate and display, based on the at least one panel view, a lane view corresponding to a target view dimension.

S240: Determine, based on the lane view, blocked panel views with duplicated display positions to perform personnel allocation based on the blocked panel views.

It should be noted that for the follow-up of complex projects, due to a large amount of work involved, there may be cases that the same executing user needs to process more project contents, leading to a work backlog and affecting project progress.

In this embodiment, after obtaining the lane view, the lane view may be filtered based on preset filtering fields, and the various panel views in the lane view are arranged based on the preset filtering fields. Further, the display positions of the various panel views in the current lane view are determined, thereby determining the views with the duplicated display positions, and considering the views as the blocked panel views. In practical applications, after determining the blocked panel views, the panel views with the duplicated display positions may be rearranged, thereby facilitating human resource allocation. The settings have the advantages that the user may be effectively helped to find block nodes based on the blocked panel views, thereby assisting more reasonable allocation of the human resources, and achieving an effect of accelerating project processing progress.

It should be noted that personnel allocation based on the blocked panel views may be achieved through the drag-and-drop operation on the panel views, or by editing the panel views, or through other methods. This embodiment of the present disclosure does not impose specific limitations on this.

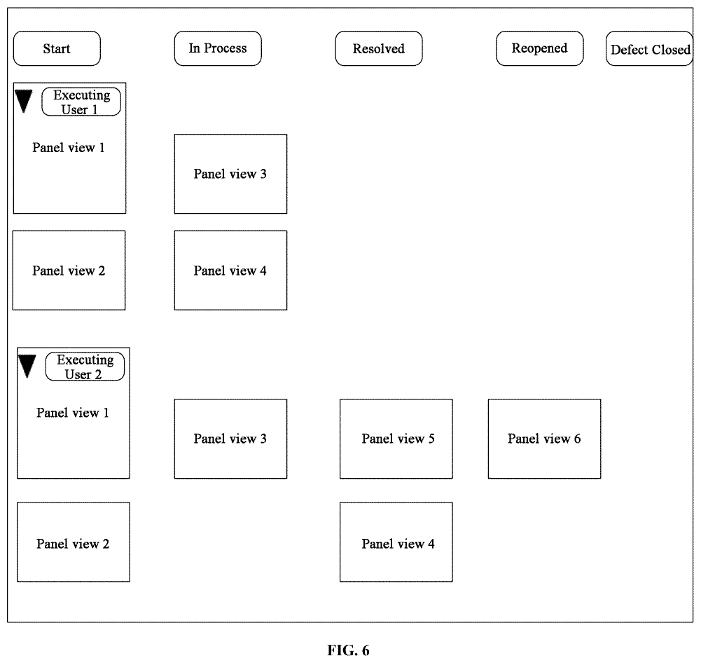

Exemplarily, as shown in FIG. 6, for the executing user 1, there may be four project requirements associated with the executing user, corresponding to four panel views: namely, the panel view 1, the panel view 2, the panel view 3, and the panel view 4. If the panel view 1 and the panel view 2 are in a [Start] column, and the panel view 3 and the panel view 4 are in an [In Process] column, it may be determined that the executing user 1 has a work backlog and project process nodes are blocked. In this case, the panel view 3 and/or the panel view 4 may be moved to other progress columns, or the two panel views may be edited to change corresponding progress statuses, thereby achieving allocation for the executing user 1.

In this embodiment of the present disclosure, by acquiring the project management data corresponding to the target user, further processing the project management data based on the preset data splitting dimension to obtain the at least one panel view, generating and displaying, based on the at least one panel view, the lane view corresponding to the target view dimension, and finally, determining, based on the lane view, the blocked panel views with the duplicated display positions, so as to perform personnel allocation based on the blocked panel views, the effect of the multi-dimensional grouping display of the panel views in the same display interface is achieved, thereby allowing the user to browse more clearly and visually, satisfying the personalized requirements of the user, facilitating the identification of the blocked nodes in the project execution process, and then achieving more reasonable human resource allocation.

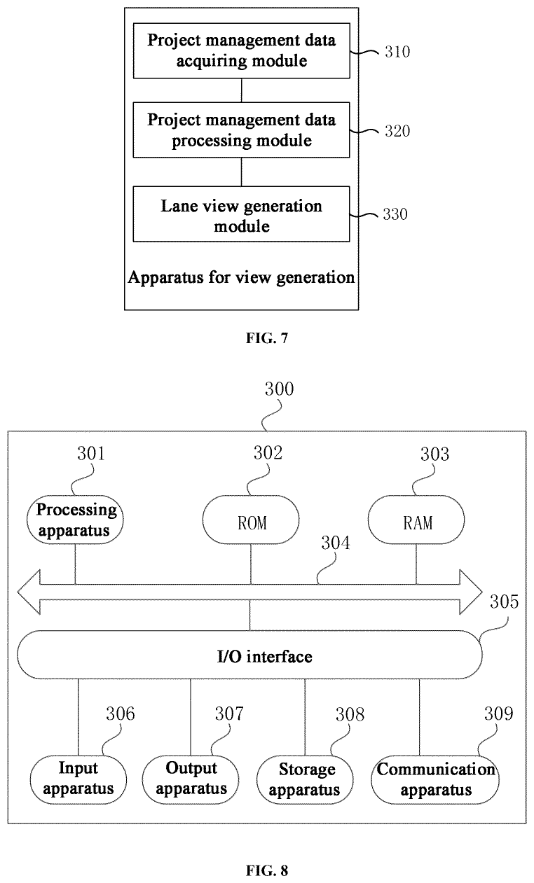

FIG. 7 is a schematic diagram of a structure of an apparatus for view generation according to an embodiment of the present disclosure. As shown in FIG. 7, the apparatus includes: a project management data acquiring module 310, a project management data processing module 320, and a lane view generation module 330.

The project management data acquiring module 310 is configured to acquire project management data corresponding to a target user, where the project management data includes an executing user, an executing node, and a node attribute;

the project management data processing module 320 is configured to process the project management data based on a preset data splitting dimension to obtain at least one panel view; and

the lane view generation module 330 is configured to generate and display, based on the at least one panel view, a lane view corresponding to a target view dimension.

Based on the above embodiments, the data splitting dimension includes at least one of a role dimension, a permission dimension, a progress dimension, a processing time dimension, a requirement processing quantity dimension, a business type dimension, or a duration dimension.

Based on the above embodiments, the project management data processing module 320 includes a project management data splitting unit and a panel view generation unit.

The project management data splitting unit is configured to split, based on the data splitting dimension, the project management data into at least one set of sub-data; and

the panel view generation unit is configured to generate the panel view based on the at least one set of sub-data.

Based on the above embodiments, the lane view generation module 330 is configured to generate the lane view based on a horizontal layout dimension in the target view dimension and a vertical layout dimension corresponding to the data splitting dimension.

Based on the above embodiments, the apparatus further includes: a panel view determination module and a horizontal layout dimension display module.

The panel view determination module is configured to determine, based on the data splitting dimension, at least one panel view located in a first column; and
the horizontal layout dimension display module is configured to display a corresponding horizontal layout dimension at a target position of the at least one panel view.

Based on the above embodiments, the panel view includes a functional control and a basic information display control, thereby displaying basic information corresponding to the panel view when the basic information display control is triggered, and displaying a functional sub-control for comments, follows, and/or chats when the functional control is triggered.

Based on the above embodiments, the panel view further includes a hide and display control, such that the panel view is displayed in a folded manner when the hide and display control is triggered.

Based on the above embodiments, the apparatus further includes: a content editing page display module.

The content editing page display module is configured to display a content editing page when a control for editing the content of the panel view is detected, and update the panel view and a display position of the panel view in the lane view according to the edited content.

Based on the above embodiments, the apparatus further includes: a display position update module.

The display position update module is configured to update, in the case of detecting a drag-and-drop operation on the panel view, the display position of the panel view in the lane view based on the drag-and-drop operation.

Based on the above embodiments, the apparatus further includes: a blocked panel view determination module.

The blocked panel view determination module is configured to determine, based on the lane view, blocked panel views with duplicated display positions to perform personnel allocation based on the blocked panel views.

In this embodiment of the present disclosure, by acquiring the project management data corresponding to the target user, further processing the project management data based on the preset data splitting dimension to obtain the at least one panel view, and finally generating and displaying, based on the at least one panel view, the lane view corresponding to the target view dimension, the effect of the multi-dimensional grouping display of the panel views in the same display interface is achieved, thereby allowing the user to browse more clearly and visually, satisfying the personalized requirements of the user, and enhancing user experience.

The apparatus for view generation provided by this embodiment of the present disclosure may perform the method for view generation provided by any embodiment of the present disclosure, and has the corresponding functional modules and beneficial effects for performing the method.

It should be noted that the various units and modules included in the above apparatus are only divided according to functional logics, but are not limited to the above division, as long as the corresponding functions can be achieved; and in addition, the specific names of the functional units are only for the convenience of distinguishing each other, and are not used to limit the scope of protection of the embodiments of the present disclosure.

FIG. 8 is a schematic diagram of a structure of an electronic device according to an embodiment of the present disclosure. Referring to FIG. 8 as below, FIG. 8 illustrates a schematic diagram of a structure of an electronic device (e.g., a terminal device or a server in FIG. 8) 300 suitable for implementing an embodiment of the present disclosure. The terminal device in this embodiment of the present disclosure may include, but is not limited to, mobile terminals such as a mobile phone, a notebook computer, a digital broadcast receiver, a personal digital assistant (PDA), a portable Android device (PAD), a portable media player (PMP), and a vehicle-mounted terminal (e.g., a vehicle navigation terminal), and fixed terminals such as a digital television (TV) and a desktop computer. The electronic device shown in FIG. 8 is merely an example and should not impose any limitations on the functions and scope of use of this embodiment of the present disclosure.

As shown in FIG. 8, the electronic device 300 may include a processing apparatus (e.g., a central processing unit and a graphics processing unit) 301 that may perform various suitable actions and processes based on a program stored in a read-only memory (ROM) 302 or a program loaded from a storage apparatus 308 into a random access memory (RAM) 303. The RAM 303 further stores various programs and data required for the operation of the electronic device 300. The processing apparatus 301, the ROM 302, and the RAM 303 are connected to one another through a bus 304. An input/output (I/O) interface 305 is also connected to the bus 304.

Typically, the following apparatuses may be connected to the I/O interface 305: an input apparatus 306, including, for example, a touchscreen, a touchpad, a keyboard, a mouse, a camera, a microphone, an accelerometer, and a gyroscope; an output apparatus 307, including, for example, a liquid crystal display (LCD), a speaker, and a vibrator; the storage apparatus 308, including, for example, a magnetic tape and a hard drive; and a communication apparatus 309. The communication apparatus 309 may allow the electronic device 300 to be in wireless or wired communication with other devices for data exchange. Although FIG. 8 illustrates the electronic device 300 with various apparatuses, it should be understood that it is not necessary to implement or have all the shown apparatuses. It may be an alternative to implement or have more or fewer apparatuses.

In particular, the foregoing process described with reference to the flowcharts according to the embodiments of the present disclosure may be implemented as a computer software program. For example, an embodiment of the present disclosure includes a computer program product, which includes a computer program carried on a non-transitory computer-readable medium, where the computer program includes program code used to perform the method shown in the flowchart. In this embodiment, the computer program may be downloaded and installed from the network through the communication apparatus 309, or installed from the storage apparatus 308, or installed from the ROM 302. The computer program, when executed by the processing apparatus 301, performs the above functions defined in the method in the embodiments of the present disclosure.

The names of messages or information exchanged between a plurality of apparatuses in the implementations of the present disclosure are used for illustrative purposes only, and are not used to limit the scope of these messages or information.

The electronic device provided by this embodiment of the present disclosure and the method for view generation provided by the above embodiment belong to the same inventive concept, and for technical details not described in detail in this embodiment, reference may be made to the above embodiment. This embodiment and the above embodiment have the same beneficial effects.

An embodiment of the present disclosure provides a computer storage medium, storing a computer program. The program, when executed by a processor, implements the method for view generation provided by the above embodiment.

It should be noted that the above computer-readable medium described in the present disclosure may be a computer-readable signal medium, or a computer-readable storage medium, or any combination of the above. The computer-readable storage medium may be, for example, but is not limited to, electric, magnetic, optical, electromagnetic, infrared, or semiconductor systems, apparatuses, or devices, or any combination of the above. More specific examples of the computer-readable storage medium may include, but are not limited to: an electrical connection with one or more wires, a portable computer disk, a hard drive, a random access memory (RAM), a read-only memory (ROM), an erasable programmable read-only memory (EPROM) or a flash, an optical fiber, a portable compact disc read-only memory (CD-ROM), an optical storage device, a magnetic storage device, or any suitable combination of the above. In the present disclosure, the computer-readable storage medium may be any tangible medium containing or storing a program which may be used by or in combination with an instruction execution system, apparatus, or device. However, in the present disclosure, the computer-readable signal medium may include a data signal propagated in a baseband or as a part of a carrier, where the data signal carries computer-readable program code. The propagated data signal may take various forms, including but not limited to an electromagnetic signal, an optical signal, or any suitable combination of the above. The computer-readable signal medium may also be any computer-readable medium other than the computer-readable storage medium. The computer-readable signal medium may send, propagate, or transmit a program used by or in combination with the instruction execution system, apparatus, or device. The program code included in the computer-readable medium may be transmitted by any suitable medium including but not limited to a wire, an optical cable, radio frequency (RF), etc., or any suitable combination of the above.

In some implementations, a client and a server may communicate using any currently known or future-developed network protocols such as a hypertext transfer protocol (HTTP), and may be interconnected with digital data communication in any form or medium (e.g., a communication network). Examples of the communication network include a local area network (LAN), a wide area network (WAN), Internet work (e.g., Internet), a peer-to-peer network (e.g., an ad hoc peer-to-peer network), and any currently known or future-developed networks.

The computer-readable medium may be included in the above electronic device; or may also separately exist without being assembled in the electronic device.

The computer-readable medium carries one or more programs. The one or more programs, when executed by the electronic device, cause the electronic device to:
acquire project management data corresponding to a target user, where the project management data includes an executing user, an executing node, and a node attribute;
process the project management data based on a preset data splitting dimension to obtain at least one panel view; and
generate and display, based on the at least one panel view, a lane view corresponding to a target view dimension.

The storage medium may be a non-transitory storage medium.

Computer program code for performing operations of the present disclosure may be written in one or more programming languages or a combination thereof, where the programming languages include, but are not limited to, object-oriented programming languages, such as Java, Smalltalk, and C++, and further include conventional procedural programming languages, such as “C” language or similar programming languages. The program code may be executed entirely on a user computer, partly on the user computer, as a stand-alone software package, partly on the user computer and partly on a remote computer, or entirely on the remote computer or the server. In the case of involving the remote computer, the remote computer may be connected to the user computer through any type of network, including a local area network (LAN) or a wide area network (WAN), or may be connected to an external computer (e.g., utilizing an Internet service provider for Internet connectivity).

The flowcharts and the block diagrams in the accompanying drawings illustrate the possibly implemented system architecture, functions, and operations of the system, the method, and the computer program product according to the various embodiments of the present disclosure. In this regard, each block in the flowcharts or the block diagrams may represent a module, a program segment, or a part of code, and the module, the program segment, or the part of code contains one or more executable instructions for implementing specified logical functions. It should also be noted that in some alternative implementations, the functions marked in the blocks may also occur in an order different from that marked in the accompanying drawings. For example, two blocks shown in succession may actually be performed substantially in parallel, or may sometimes be performed in a reverse order, depending on the functions involved. It should also be noted that each block in the block diagrams and/or the flowcharts, and a combination of the blocks in the block diagrams and/or the flowcharts may be implemented by using a dedicated hardware-based system that performs specified functions or operations, or may be implemented by using a combination of dedicated hardware and computer instructions.

The related units described in the embodiments of the present disclosure may be implemented by software or hardware. Names of the units do not constitute a limitation on the units themselves in some cases. For example, a first acquiring unit may alternatively be described as “a unit for acquiring at least two Internet protocol addresses”.

Herein, the functions described above may be at least partially executed by one or more hardware logic components. For example, exemplary hardware logic components that can be used include, but are not limited to: a field programmable gate array (FPGA), an application specific integrated circuit (ASIC), application specific standard parts (ASSPs), a system on chip (SOC), a complex programmable logic device (CPLD), etc.

In the context of the present disclosure, a machine-readable medium may be a tangible medium that may contain or store a program used by or in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above content. More specific examples of the machine-readable storage medium may include an electrical connection based on one or more wires, a portable computer disk, a hard drive, a random access memory (RAM), a read-only memory (ROM), an erasable programmable read-only memory (EPROM) or a flash memory, an optical fiber, a portable compact disc read-only memory (CD-ROM), an optical storage device, a magnetic storage device, or any suitable combination of the above content.

According to one or more embodiments of the present disclosure, [Example 1] provides a method for view generation, including:
acquiring project management data corresponding to a target user, where the project management data includes an executing user, an executing node, and a node attribute;
processing the project management data based on a preset data splitting dimension to obtain at least one panel view; and
generating and displaying, based on the at least one panel view, a lane view corresponding to a target view dimension.

According to one or more embodiments of the present disclosure, [Example 2] provides a method for view generation, further including:
the data splitting dimension including at least one of a role dimension, a permission dimension, a progress dimension, a processing time dimension, a requirement processing quantity dimension, a business type dimension, or a duration dimension.

According to one or more embodiments of the present disclosure, [Example 3] provides a method for view generation, further including:
processing the project management data based on a preset data splitting dimension to obtain at least one panel view including:
splitting, based on the data splitting dimension, the project management data into at least one set of sub-data; and
generating the panel view based on the at least one set of sub-data.

According to one or more embodiments of the present disclosure, [Example 4] provides a method for view generation, further including:
generating, based on the at least one panel view, a lane view corresponding to a target view dimension including:
generating the lane view based on a horizontal layout dimension in the target view dimension and a vertical layout dimension corresponding to the data splitting dimension.

According to one or more embodiments of the present disclosure, [Example 5] provides a method for view generation, further including:
the method further including:
determining, based on the data splitting dimension, at least one panel view located in a first column; and
displaying a corresponding horizontal layout dimension at a target position of the at least one panel view.

According to one or more embodiments of the present disclosure, [Example 6] provides a method for view generation, further including:
the panel view including a functional control and a basic information display control, such that basic information corresponding to the panel view is displayed when the basic information display control is triggered, and a functional sub-control for comments, follows, and/or chats is displayed when the functional control is triggered.

According to one or more embodiments of the present disclosure, [Example 7] provides a method for view generation, further including:
the panel view further including a hide and display control, such that the panel view is displayed in a folded manner when the hide and display control is triggered.

According to one or more embodiments of the present disclosure, [Example 8] provides a method for view generation, further including:
the method further including:
displaying a content editing page when a control for editing the content of the panel view is detected, and updating the panel view and a display position of the panel view in the lane view according to the edited content.

According to one or more embodiments of the present disclosure, [Example 9] provides a method for view generation, further including:
the method further including:
updating, in the case of detecting a drag-and-drop operation on the panel view, the display position of the panel view in the lane view based on the drag-and-drop operation.

According to one or more embodiments of the present disclosure, [Example 10] provides a method for view generation, further including:
the method further including:
determining, based on the lane view, blocked panel views with duplicated display positions to perform personnel allocation based on the blocked panel views.

According to one or more embodiments of the present disclosure, [Example 11] provides an apparatus for view generation, including:
a project management data acquiring module, configured to acquire project management data corresponding to a target user, where the project management data includes an executing user, an executing node, and a node attribute;
a project management data processing module, configured to process the project management data based on a preset data splitting dimension to obtain at least one panel view; and
a lane view generation module, configured to generate and display, based on the at least one panel view, a lane view corresponding to a target view dimension.

Those skilled in the art should understand that the scope of open in the present disclosure is not limited to the embodiments formed by specific combinations of the above technical features, and should also cover other embodiments formed by arbitrary combinations of the above technical features or equivalent features without departing from the concept of the disclosure, such as embodiments formed by replacing the above features with the technical features with similar functions disclosed (but not limited to) in the present disclosure.

In addition, although the various operations are depicted in a specific order, it should not be understood as requiring these operations to be performed in the shown particular order or in a sequential order. In certain environments, multitasking and parallel processing may be advantageous. Similarly, although several specific implementation details are included in the above discussion, these specific implementation details should not be interpreted as limitations on the scope of the present disclosure. Some features that are described in the context of separate embodiments may also be implemented in combination in a single embodiment. In contrast, various features described in the context of a separate embodiment may alternatively be implemented in a plurality of embodiments individually or in any suitable subcombination.

Although the subject matter has been described in a language specific to structural features and/or logic actions of the method, it should be understood that the subject matter defined in the appended claims is not necessarily limited to the specific features or actions described above. On the contrary, the specific features and the actions described above are merely example forms for implementing the claims.

1. A method for view generation, comprising:
acquiring project management data corresponding to a target user, wherein the project management data comprises an executing user, an executing node, and a node attribute;
processing the project management data based on a preset data splitting dimension to obtain at least one panel view; and
generating and displaying, based on the at least one panel view, a lane view corresponding to a target view dimension.

2. The method according to claim 1, wherein the data splitting dimension comprises at least one of a role dimension, a permission dimension, a progress dimension, a processing time dimension, a requirement processing quantity dimension, a business type dimension, or a duration dimension.

3. The method according to claim 1, wherein processing the project management data based on the preset data splitting dimension to obtain the at least one panel view comprises:
splitting, based on the data splitting dimension, the project management data into at least one set of sub-data; and
generating the panel view based on the at least one set of sub-data.

4. The method according to claim 1, wherein generating, based on the at least one panel view, the lane view corresponding to the target view dimension comprises:
generating the lane view based on a horizontal layout dimension in the target view dimension and a vertical layout dimension corresponding to the data splitting dimension.

5. The method according to claim 4, further comprising:
determining, based on the data splitting dimension, at least one panel view located in a first column; and
displaying a corresponding horizontal layout dimension at a target position of the at least one panel view.

6. The method according to claim 1, wherein the panel view comprises a functional control and a basic information display control, such that basic information corresponding to the panel view is displayed when the basic information display control is triggered, and at least one of functional sub-controls for comments, follows, or chats is displayed when the functional control is triggered.

7. The method according to claim 1, wherein the panel view further comprises a hide and display control, such that the panel view is displayed in a folded manner when the hide and display control is triggered.

8. The method according to claim 1, further comprising:
displaying a content editing page in response to detecting a control for editing a content of the panel view, and updating the panel view and a display position of the panel view in the lane view according to the edited content.

9. The method according to claim 1, further comprising:
updating, in response to detecting a drag-and-drop operation on the panel view, a display position of the panel view in the lane view based on the drag-and-drop operation.

10. The method according to claim 1, further comprising:
determining, based on the lane view, blocked panel views with duplicated display positions to perform personnel allocation based on the blocked panel views.

11. (canceled)

12. An electronic device, comprising:
one or more processors; and
a storage apparatus, configured to store one or more programs,
wherein the one or more programs, when executed by the one or more processors, cause the one or more processors to:
acquire project management data corresponding to a target user, wherein the project management data comprises an executing user, an executing node, and a node attribute;
process the project management data based on a preset data splitting dimension to obtain at least one panel view; and
generate and display, based on the at least one panel view, a lane view corresponding to a target view dimension.

13. A non-transitory storage medium comprising computer-executable instructions, wherein the computer-executable instructions, when executed by a computer processor, are used to:
acquire project management data corresponding to a target user, wherein the project management data comprises an executing user, an executing node, and a node attribute;
process the project management data based on a preset data splitting dimension to obtain at least one panel view; and
generate and display, based on the at least one panel view, a lane view corresponding to a target view dimension.

14. The non-transitory storage medium according to claim 13, wherein the data splitting dimension comprises at least one of a role dimension, a permission dimension, a progress dimension, a processing time dimension, a requirement processing quantity dimension, a business type dimension, or a duration dimension.

15. The non-transitory storage medium according to claim 13, wherein the computer-executable instructions for processing the project management data based on the preset data splitting dimension to obtain the at least one panel view are further used to:
split, based on the data splitting dimension, the project management data into at least one set of sub-data; and
generate the panel view based on the at least one set of sub-data.

16. The non-transitory storage medium according to claim 13, wherein the computer-executable instructions for generating, based on the at least one panel view, the lane view corresponding to the target view dimension are further used to:
generate the lane view based on a horizontal layout dimension in the target view dimension and a vertical layout dimension corresponding to the data splitting dimension.

17. The non-transitory storage medium according to claim 16, wherein the computer-executable instructions are further used to:
determine, based on the data splitting dimension, at least one panel view located in a first column; and
display a corresponding horizontal layout dimension at a target position of the at least one panel view.

18. The non-transitory storage medium according to claim 13, wherein the panel view comprises a functional control and a basic information display control, such that basic information corresponding to the panel view is displayed when the basic information display control is triggered, and at least one of functional sub-controls for comments, follows, or chats is displayed when the functional control is triggered.

19. The non-transitory storage medium according to claim 13, wherein the panel view further comprises a hide and display control, such that the panel view is displayed in a folded manner when the hide and display control is triggered.

20. The non-transitory storage medium according to claim 13, wherein the computer-executable instructions are further used to:
display a content editing page in response to detecting a control for editing a content of the panel view, and update the panel view and a display position of the panel view in the lane view according to the edited content.

21. The non-transitory storage medium according to claim 13, wherein the computer-executable instructions are further used to:
update, in response to detecting a drag-and-drop operation on the panel view, a display position of the panel view in the lane view based on the drag-and-drop operation.
